(19) United States
(12) Patent Application Publication
(10) Pub. No.: US 2026/0118285 A1
(43) Pub. Date: Apr. 30, 2026

(54) MEASURING ASSEMBLY

(71) Applicant: Endress+Hauser Flowtec AG, Reinach (CH)

(72) Inventors: Frank Voigt, Weil am Rhein (DE); Anne Habermehl, München (DE); Stefan Pflüger, München (DE)

(21) Appl. No.: 19/124,555

(22) PCT Filed: Sep. 18, 2023
(86) PCT No.: PCT/EP2023/075636

§ 371 Date: Apr. 25, 2025

(30) Foreign Application Priority Data
Nov. 4, 2022 (DE) 10 2022 129 178.2

(51) Int. Cl. G01N 22/00

(52) U.S. Cl. CPC G01N 22/00

(57) ABSTRACT

A measuring assembly for determining a property of a multiphase flowable medium comprises a measuring tube for carrying the medium, the measuring tube having a first antenna receptacle, a first microwave antenna, which is arranged in the first antenna receptacle, a first separating disc for separating the first microwave antenna from the medium, the first separating disc being arranged in the first antenna receptacle, and the first microwave antenna being arranged behind the first separating disc in the radial direction, a measurement circuit, the measurement circuit having a high-frequency generator for supplying the first microwave antenna with an excitation signal, in particular with a sequence of high-frequency signals, and the measurement circuit being configured to determine the property of the medium on the basis of a received measurement signal.

The invention relates to a measuring assembly for determining a property of a multiphase, flowable medium.

It is possible, by means of microwaves, to determine the physical quantities of permittivity and loss factor of a medium in a process line. From these two variables—measured either at one or over many different frequencies—it is possible to draw conclusions regarding application-specific parameters, for example the proportion of water in a mixture of water and other non-polar or weakly polar components or a solid content in a liquid medium.

The established transmission/reflection measurement is described in L. F. Chen, C. K. Ong, C. P. Neo, V. V. Varadan, V. K. Varadan—“Microwave Electronics, Measurement and Materials Characterization,” John Wiley & Sons Ltd., 2004. For this purpose, the microwave signal interfaces at two different positions at the medium in a container or measuring tube, the scatter parameters (transmission and optionally reflection) are measured between these interface structures, and the mentioned physical properties of the medium are calculated from the measured scatter parameters.

WO 2018 121927 A1 teaches a measuring assembly for analyzing properties of a flowing medium by means of microwaves. In addition to the microwave antennas, the measuring assembly has an electrically insulating lining layer on the inner peripheral surface of the measuring tube. This lining layer forms a dielectric waveguide via which at least part of the one microwave signal can travel from a first microwave antenna to a second microwave antenna. One application for such a measuring assembly is the determination of the proportions of solids in the liquid medium being conveyed. WO 2021/099152 A1 teaches a microwave antenna which has a front section in contact with the medium, via which the excitation signal is emitted into the medium. A disadvantage of the disclosed solutions is that they are not suitable for hygiene applications in the disclosed form.

The object of the invention is to remedy this problem.

The object is achieved by the measuring assembly according to claim 1.
The measuring assembly according to the invention for determining a property of a multi-phase, flowable medium comprises:
preferably a metal measuring tube for carrying the medium,
wherein the measuring tube has a first antenna receptacle,
a first microwave antenna which is arranged in the first antenna receptacle,
a first separating disc for separating the first microwave antenna from the medium,
wherein the first separating disc is arranged in the first antenna receptacle,
wherein the first microwave antenna is arranged behind the first separating disc in the radial direction,
a measuring circuit,
wherein the measurement circuit has a high-frequency generator for supplying the first microwave antenna with an excitation signal, in particular with a sequence of high-frequency signals,
wherein the measurement circuit is configured to determine the property of the medium on the basis of a received measurement signal.

The advantage of the measuring assembly according to the invention is that measuring assemblies for wastewater or pulp-and-paper applications, in which the first microwave antenna is in direct contact with the medium, can be easily converted for hygiene applications. This is achieved by means of the first separating disc which is arranged between the medium to be guided and the first microwave antenna and accordingly prevents the first microwave antenna from coming into contact with the medium. The first separating disc can be designed in such a way that it meets the application-related hygiene requirements. For this purpose, a special material with which the medium may come into contact or a special geometry in which undercuts are avoided can be provided. It is also advantageous that with a suitable choice of material and geometry of the first separating disc, improved irradiation of the excitation signal into the medium is achieved.

Within the meaning of the invention, the separating disc is to be understood as a disc. A disc is a geometric body which, at least partially, assumes the shape of a cylinder and whose disc radius is, at least partially, many times higher than its thickness. The separating disc cannot therefore be understood as part of a liner applied to the inside of the measuring tube within the meaning of WO 2018/121927 A1, as a waveguide within the meaning of U.S. Pat. No. 4,755,743, as part of an electrically insulating measuring tube body within the meaning of U.S. Pat. No. 3,999,443 or as an electrically insulating sheath within the meaning of WO 00/43759 A1.

The high-frequency generator is preferably configured to generate an excitation signal which covers a frequency range from 100 MHz to 100 GHz, in particular from 500 MHz to 50 GHz and preferably from 800 MHz to 15 GHz. The first microwave antenna is designed to radiate the provided excitation signal into the interior of the measuring tube or into the medium. The excitation signal is a microwave signal which is substantially free from the influence of the medium in the measuring tube. The first microwave antenna can also detect the reflected back-propagating measurement signal. The measurement signal is also a microwave signal which substantially comprises the excitation signal with a component resulting from the interaction of the excitation signal with the medium. The measurement circuit has a microcontroller, logic switching elements and/or electrical components and is designed to determine a property of the medium depending on the proportion.

Advantageous embodiments of the invention are the subject-matter of the dependent claims.
One embodiment provides that the first separating disc comprises a material which is listed in the following list:
polyetheretherketones (PEEK)
polytetrafluoroethylene (PTFE)
perfluoroalkoxy (PFA)
glass
ceramic

In terms of hygienic design, the material must meet the applicable standards and guidelines for contact with food required in the application such as applicable parts of the US FDA (2022). The material preferably meets the requirements of FDA (2022), EHEDG, in particular EN 1672-2 and/or DIN EN ISO 14159:2008-07, 3-A Sanitary Standards, (EC) No. 1935/2004, (EU) No. 10/2011, GB 4806.1-2016, GB 4806.7-2016 and/or GB 4806.11-2016.
One embodiment provides that the first separating disc has a first separating disc receptacle in which the first microwave antenna is arranged, in particular fused.

The advantage of a fused connection between the first microwave antenna and the first separating disc receptacle or the first separating disc is the improved coupling of the generated excitation signal into the separating disc.
One embodiment provides that the first separating disc has a first separating disc section with a first separating disc thickness d₁,
wherein the first separating disc has a second separating disc section with a second separating disc thickness d₂,
wherein the first separating disc thickness d₁ is smaller than the second separating disc thickness d₂,
wherein the first separating disc section forms a minimum separation between the medium and the first microwave antenna.

It is advantageous if the distance between the first microwave antenna and the medium is as small as possible. The first separating disc has several separating disc thicknesses to improve the connection of the first microwave antenna to the first separating disc itself and to achieve the most optimum mechanical stability of the first separating disc. This allows the first section of the separating disc through which the excitation signal propagates to be made as thin as possible. For the second separating disc section—through which a much smaller amount of the excitation signal propagates—a comparatively high separating disc thickness can be provided to improve the mechanical stability of the first separating disc.
One embodiment provides that the first separating disc thickness d₁ is a maximum of 1 millimeter, in particular a maximum of 1.5 millimeters and preferably a maximum of 2 millimeters.

It has been found that the portion of the excitation signal radiated into the medium that is useful for the measurements (the reflection factor is below −6 dB, i.e. at least 75% of the power is radiated) decreases with increasing thickness of the separating disc. For the claimed measuring assembly it could be demonstrated that with a separating disc thickness d₁ of 1 millimeter approximately 90% of the useful band (1.8-3 GHz), with a separating disc thickness d₁ of 2 millimeters only about 75% of the usable band and with a separating disc thickness d₁ of 3 millimeters, only about 50% of the useful band is below −6 dB. This means that in the latter case. only half of the useful band contributes to determining the properties of the multiphase, flowable medium.
One embodiment provides that the measuring tube has a measuring tube collar extending around a circumference of the first antenna receptacle.

The measuring tube collar has the advantage that it increases the mechanical stability of the first antenna receptacle and therefore also the robustness of the entire measuring assembly, in particular the module comprising the first microwave antenna, the first separating disc and any other components.

One embodiment provides that the measuring tube has a first measuring tube section with a first outer diameter D₁,
wherein the measuring tube has a second measuring tube section with a second outer diameter D₂,
wherein the first outer diameter D₁ is larger than the second outer diameter D₂,
wherein the first antenna receptacle is located in the first measuring tube section.
One embodiment provides that the measuring tube has a measuring section in which the first microwave antenna is arranged,
wherein the measuring tube is spherical in the measuring section.

The advantage of the embodiment is that a circular first antenna receptacle can be realized in the measuring tube for an at least partially cylindrical separating disc without undercuts forming between the measuring tube and the first separating disc in which solids of the medium can accumulate. By arranging the first separating discs flush with the front of the measuring tube, no steps are formed in the medium-carrying measuring tube channel and therefore no source of turbulence in the medium.
One embodiment comprises:
a first disc holder for fixing the first separating disc in the first antenna receptacle,
wherein the first disc holder is designed and arranged on the measuring tube in such a way that the first separating disc is clamped in the first antenna receptacle.
One embodiment provides that the first separating disc has, in a front section, a sealing agent receptacle running along the circumference, in particular in the form of an indentation, with a sealing agent arranged therein.

The sealing means can be a sealing means in a solid state during assembly (e.g. an O-ring) or a sealing means initially applied in liquid form and then hardened.
One embodiment provides that the first microwave antenna has a metallic carrier body with a carrier body receptacle,
wherein the first microwave antenna has a ceramic with a metallization, which is arranged in the carrier body receptacle,
wherein the first microwave antenna has an opening extending through the carrier body and the ceramic,
wherein the first microwave antenna comprises a coaxial connector that is arranged in the opening.

The advantage of the design is the high compactness of the first microwave antenna with high pressure and temperature resistance. Such a first microwave antenna is known from WO 2021/099152 A1, to which reference is made in its entirety.
One embodiment comprises:
a first disc fastener which is designed to fix the first separating disc to the disc holder and/or the first microwave antenna and to shield the first microwave antenna.

The first disc fastener lies on the back of the first microwave antenna. The advantage of this is that the signal loss of the excitation signal is reduced by preventing a portion of the excitation signal from being emitted via the rear side. It is further advantageous if the first disc fastener additionally or alternatively covers or shields a lateral surface of the first microwave antenna.
One embodiment provides that the first disc fastener and the first disc holder are designed and arranged around the first microwave antenna in such a way that a ground connection to the metallization (i.e. a connection to ground via the metallization) is realized.

The metallization of the disc holder prevents the microwave signal (excitation signal) from partially radiating into the electronics chamber instead of into the medium.
One embodiment comprises:
a second microwave antenna, in particular structurally identical to the first microwave antenna,
wherein the measuring tube has a second antenna receptacle, in particular diametrically oriented to the first antenna receptacle,
wherein the second microwave antenna is arranged in the second antenna receptacle,
a second separating disc for separating the second microwave antenna from the medium,
wherein the second separating disc is arranged in the second antenna receptacle,
wherein the second microwave antenna is arranged behind the second separating disc in a radial direction,
wherein the second microwave antenna is designed to receive the microwave signal.
One embodiment comprises:
a second disc holder for fixing the second separating disc in the second antenna receptacle,
wherein the second disc holder is designed and arranged on the measuring tube in such a way that the second separating disc is clamped in the second antenna receptacle.
One embodiment provides that the measuring tube has a measuring tube interior,
wherein the first disc holder is connected to the second disc holder via at least one fastening means,
wherein the first disc holder and the second disc holder is arranged on the measuring tube and connected to one another in such a way that they cause a force in the direction of the measuring tube interiors on the respective disc holder.

The invention is explained in greater detail with reference to the following figures. In the figures:

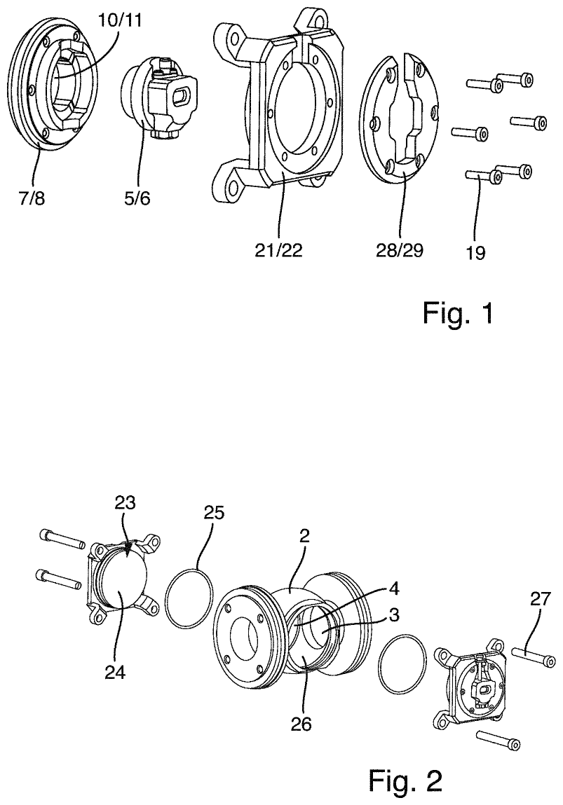

FIG. 1: shows an exploded view of a module of a first embodiment of the measuring assembly according to the invention;

FIG. 2: shows an exploded view of the entire first embodiment of the measuring tube according to the invention,

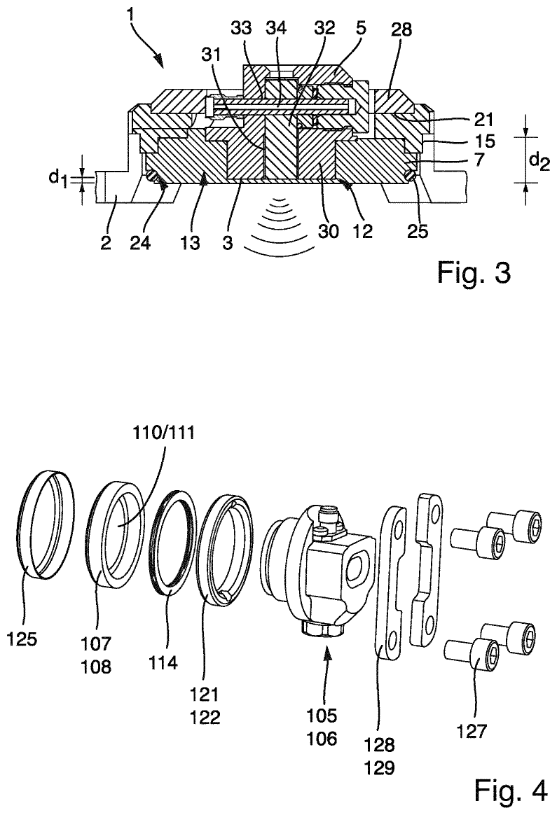

FIG. 3: shows a cross section through a first embodiment of the measuring assembly;

FIG. 4: shows an exploded view of a module of a second embodiment of the measuring assembly according to the invention;

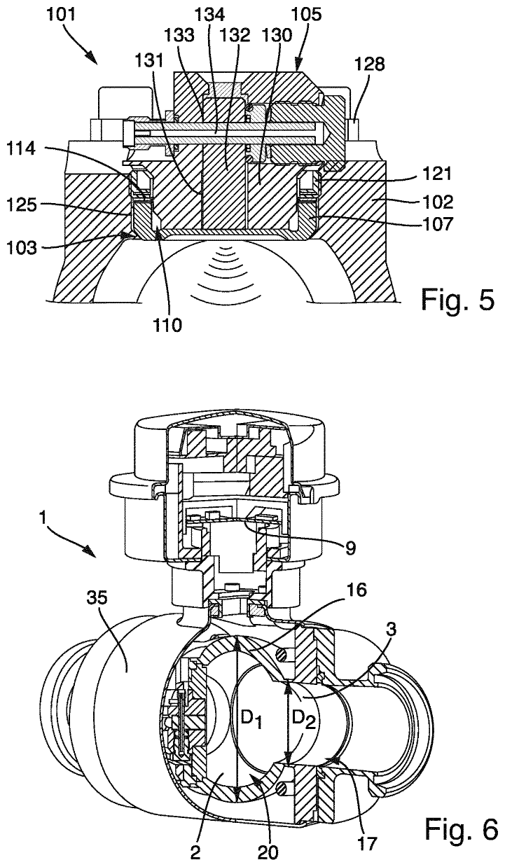

FIG. 5: shows a cross section through a second embodiment of the measuring assembly;

FIG. 6: shows a perspective and partially cutaway view of the measuring assembly according to the invention.

FIG. 1 shows an exploded view of a module of a first embodiment of the measuring assembly 1 according to the invention. The depicted module comprises a first separating disc 7 which is designed to separate the first microwave antenna 5 from the flowable medium. The first separating disc 7 is intended to prevent the first microwave antenna 5 from coming into contact with the flowing medium. The first separating disc 7 is designed to meet the requirements of FDA, (EC) No. 1935/2004, GB 4806.1-2016, GB 4806.7-2016 and/or GB 4806.11-2016. Furthermore, the first separating disc 7 has a first separating disc receptacle 10 which can be designed as a recess. For this purpose, it preferably has or is made of PEEK, PTFE, PFA, glass or ceramic as material. The first separating disc receptacle 10 is designed in such a way that a first microwave antenna 5 can be arranged at least partially therein. For sufficient fastening, a material-to-fused fastening of the first microwave antenna 5 in the first separating disc receptacle 10 can be provided. The first microwave antenna 5 is designed to transmit an excitation signal into the medium. Furthermore, the first microwave antenna 5 has a metallization on an outer lateral surface. The module further comprises a first disc holder 21 which is designed to fasten the first separating disc 7 to a measuring tube. For this purpose, the first disc holder 21 is designed and can be arranged on the measuring tube in such a way that the first separating disc 7 is clamped in the first antenna receptacle (not shown) provided in the measuring tube. The first window holder 21 has an opening through which the first microwave antenna 5 can be arranged or through which the first microwave antenna 5 extends in the mounted state. The first microwave antenna 5 is attached to the first separating disc 7 and the first disc holder 21 by a first disc fastener 28. The first disc fastener 28 not only serves to fasten the first microwave antenna 5, but must also be designed and arranged in such a way that it shields the first microwave antenna 5 in the radial direction. For this purpose, the first disc fastener 28 and the disc holder 21 are designed and arranged around the first microwave antenna 5 in such a way that a ground connection to the metallization of the first microwave antenna 5 is realized. The first disc fastener 28 is mechanically connected to the first disc holder 21 and the first separating disc 7 by means of at least one fastening means 19 (e.g. screws or rivets).

When using two microwave antennas, it is advantageous to use two structurally identical microwave antennas. In this case, one of the two microwave antennas is configured to transmit the excitation signal, and the correspondingly other microwave antenna is designed to receive a measurement signal. Accordingly, the module then comprises a second separating disc 8 with a second separating disc receptacle 11, a second microwave antenna 6, a second disc holder 22 and a second disc fastener 29.

FIG. 2 shows an exploded view of the entire first embodiment of the measuring assembly 1 according to the invention. The shown measuring assembly 1 comprises two of the modules shown in FIG. 1 in an assembled state. These can be arranged diametrically on a measuring tube 2 with a first antenna receptacle 3 and a second antenna receptacle 4. For adequate sealing, a sealing means 25 is provided in each case which can be arranged in an end face sealing means receptacle 24 of the separating discs 7, 8. The sealing means 25 can be designed like a sealing ring. The measuring tube 2 has a connection device in the form of a flange on each end face. The measuring tube 2 is spherical in the region of the antenna receptacles 3, 4. The two modules can be mechanically connected to one another via fastening means 27 in such a way that they are tensioned against one another, and a mutual force is therefore exerted on the modules in the direction of the measuring tube interior 26.

FIG. 3 shows a cross section through a first embodiment of the measuring assembly 1. In the first antenna receptacle 3, the mounted module depicted in FIG. 1 is arranged in the first antenna receptacle 3 of the measuring tube 2. The first separating disc 7 has a first separating disc section 12 in which the first separating disc 7 has a first separating disc thickness d₁, and a second separating disc section 13 in which the first separating disc 7 has a second separating disc thickness d₂. The first separating disc thickness d₁ is smaller than the second separating disc thickness d₂. The first separating disc section 12 forms a minimal separation between the medium within the measuring tube interior and the first microwave antenna 5. The first separating disc thickness d₁ is a maximum of 3 millimeters, in particular a maximum of 2 millimeters and preferably a maximum of 1 millimeter. Given the design of the different separating disc thicknesses, a first antenna receptacle 3 is formed in which the first microwave antenna 5 is arranged. The first microwave antenna 5 can be fused to the first separating disc 7 by means of an adhesive. For this purpose, an adhesive gap (approx. 0.2 mm) can be provided between the end face of the first microwave antenna and the opposite surface of the first antenna receptacle, which is filled with an adhesive.

Furthermore, the first separating disc 7 has a sealing means receptacle 24 in which a sealing means 25 in the form of a sealing ring is arranged. The sealing means receptacle 24 is designed in such a way and the sealing means 25 is configured and arranged in the sealing means receptacle 24 in such a way that it is at least partially in contact with the medium and no cavities form. The sealing means 25 consists of a material suitable for hygienic applications.

A metallic first disc holder 21 is arranged in the radial direction behind the first separating disc 7 and exerts a force on the first separating disc 7 in the direction of the measuring tube interior. The first disc holder 21 can interact with a second disc holder 22 of a second module that is arranged diametrically. A first disc fastener 28 is arranged in the radial direction behind the first separating disc 7 and the first disc holder 21, and is designed to connect the first separating disc 7 to the first disc holder 21. In addition, the first disc holder 21 is designed in such a way that it covers as large a rear surface of the first microwave antenna 5 as possible and creates a connection between the metallization of the first microwave antenna 5 and the metallic first disc holder 21.

The first microwave antenna 5 has a metalized carrier body 30 with a carrier body receptacle 31 in which a ceramic 32 is arranged. The ceramic 32 has a through opening 33 through which a coaxial connector 34 is inserted. The coaxial connector 34 is connected to the measurement circuit which has a high-frequency generator for feeding the first microwave antenna 5 with an excitation signal. Alternatively, the coaxial connector 34 can be designed to forward an incoming measurement signal to the measurement circuit.

The measuring tube 2 has a measuring tube collar 15 extending around a circumference of the first antenna receptacle 3, in which the entire module is arranged. The measuring tube collar 15 facilitates installation and ensures a stable arrangement of the module on the measuring tube.

When using two structurally identical microwave antennas or modules, the measuring assembly 1 has two of the shown assemblies.

FIG. 4 shows an exploded view of a module of a second embodiment of the measuring assembly 101 according to the invention. The module comprises a first separating disc 107 which tapers conically at the end face. A sealing means 125 in the form of a sealing sleeve to be arranged on the front side of the first separating disc 107 also tapers conically at the end face. The sealing means 125 has a first sealing means section in which it is cylindrically designed and has a substantially constant first sealing means diameter. Furthermore, the sealing means 125 has a second sealing means section with a second sealing means diameter, which is always smaller than the first sealing means diameter and decreases or increases in the longitudinal direction. The first separating disc 107 can be connected to a measuring tube via a first disc holder 121. The first disc holder 121 has a thread for this purpose. A resilient element 114 is arranged between the first separating disc 107 and the first disc holder 121. In the illustrated embodiment, the resilient element 114 consists of a cylindrical leaf spring. The four individual components mentioned—the sealing means 125, the first separating disc 107, the elastic element 114 and the first disc holder 121—can be assembled together and fastened in a receptacle in the measuring tube. Thereafter, a first microwave antenna 105 can be guided through the first disc holder 121 and the resilient element 114 and can be arranged in a provided first separating disc receptacle 110 in the first separating disc 107. For fastening the first microwave antenna 105 in the first separating disc receptacle 110, a first disc fastener 128 is provided which comprises two clamp-shaped discs. Four fastening means 127 serve to fasten the module to the measuring tube. Furthermore, the first disc fastener 128 is designed and arranged behind the first microwave antenna 105 in a radial direction in such a way that the largest possible rear surface of the first microwave antenna 5 is covered.

When using two microwave antennas, it is advantageous to use two structurally identical microwave antennas. In this case, one of the two microwave antennas is configured to transmit the excitation signal, and the correspondingly other microwave antenna is designed to receive a measurement signal. Accordingly, the module then comprises a second separating disc 108 with a second separating disc receptacle 111, a second microwave antenna 106, a second disc holder 122 and a second disc fastener 129.

FIG. 5 shows a cross section through a second embodiment of the measuring assembly 101. The measuring assembly 101 has a measuring tube 102 which—unlike in FIG. 3—is not designed spherical. Instead, the medium-carrying path in a cross-section in the measuring section has a circular surface which is shortened by two diametrically oriented circular segments. The depicted measuring tube 102 is a milled part which is machined from a metallic block. However, the measuring tube 2 with the spherical measuring section from FIG. 2 would be suitable as an alternative measuring tube for the second embodiment.

The measuring tube 102 has a first antenna receptacle 103 which is formed from an opening in the measuring tube wall and a hollow cylindrical collar. In the first antenna receptacle 103, a sealing means 125, a first separating disc 107, a resilient element 114 and a first disc holder 121 are arranged. These four mentioned components serve to ensure a medium-tight boundary between the first microwave antenna 105 and the medium to be guided. The first microwave antenna 105 is arranged in a first separating disc receptacle 110 and extends through an opening of the resilient element 114 and an opening of the first disc holder 121. The first disc holder 121 has a thread and is connected to the measuring tube 102 or to the collar of the measuring tube 102 via a screw connection. The sealing means 125 and the first separating disc 107 are clamped between the first disc holder 121 and a projection of the first antenna receptacle 103. The resilient element 114 in the form of a disc spring absorbs the force generated by the first disc holder 121.

The first microwave antenna 105 is identical to the first microwave antenna 5 of FIG. 3 and accordingly also has a carrier body 130 with a carrier body receptacle 131 in which a ceramic 132, which has an opening 133, is arranged. A coaxial connector 134 is inserted through the opening 133 and is connected to the measuring circuit, in particular to the high-frequency generator. The first microwave antenna 105 is mounted in the first antenna receptacle 103 and the first separating disc receptacle 110 via a first disc mount 128. The first microwave antenna 105 has a metallic outer surface. The first disc fastener 128 is made of metal and covers at least part of the rear side of the first microwave antenna 105.

When using two structurally identical microwave antennas or modules, the measuring assembly 101 has two of the shown assemblies.

FIG. 6 shows a perspective and partially cutaway view of the measuring assembly 1 according to the invention. The measuring assembly 1 comprises a measuring sensor which is designed to couple a received excitation signal into a medium to be examined and to measure a measuring signal which correlates with the property of the medium to be examined. Furthermore, the measuring assembly 1 comprises a measuring transducer which is designed to provide an excitation signal, to evaluate the measured measuring signal, and to determine the property to be determined. For this purpose, the measuring transducer has a measurement circuit 9 which has a high-frequency generator for supplying the first microwave antenna with an excitation signal, in particular with a sequence of high-frequency signals. Furthermore, the measurement circuit 9 is configured to determine the property of the medium on the basis of a received measuring signal. For the determination, the measurement circuit 9 has a microprocessor, a memory and logical switching components. Furthermore, a computer program product which has the algorithm for determining the property of the medium can be stored in the measurement circuit 9.

The measuring assembly 1 further comprises an in particular a metallic measuring tube 2 which has a first measuring tube section 16 with a first outer diameter D₁ and a second measuring tube section 17 with a second outer diameter D₂. The first outer diameter D₁ larger than the second outer diameter D₂ and increases—starting from the second outer diameter D₂—continuously in the longitudinal direction of the measuring tube until it reaches a maximum outer diameter. After that, the first outer diameter decreases D₁. This results in a widening of the measuring tube in the first measuring tube section 16. The first antenna receptacle 3 is arranged in a first measuring tube section 16. A part of the first measuring tube section 16 is the measuring section 20. The first microwave antenna 5 is arranged in the measuring section 20. The measuring section 20 is designed spherical in the depicted embodiment. For example, a VARINLINE® housing from GEA which is designed without dead space is suitable as measuring tube 2 and is therefore ideal for hygienic applications. Furthermore, the measuring assembly 1 comprises a housing 35 which encloses the individual components of the module from FIG. 1 or the microwave antenna and protects them against external influences.

### LIST OF REFERENCE SIGNS

Measuring assembly 1, 101
Measuring tube 2, 102
First antenna receptacle 3
Second antenna receptacle 4
First microwave antenna 5, 105
Second microwave antenna 6, 106
First separating disc 7, 107
Second separating disc 8, 108
Measurement circuit 9
First separating disc receptacle 10, 110
First separating disc section 12
Second separating disk section 13
Elastic element 114
Measuring tube collar 15
First measuring tube section 16
Second measuring tube section 17
Fastening means 19
Measuring section 20
First disc holder 21, 121
Second disc holder 22, 122
Front section 23
Sealing means receptacle 24
Sealing means 25, 125
Measuring tube interior 26
Fastening means 27, 127
First disc fastener 28, 128
Second disc fastener 29, 129
Carrier body 30, 130
Carrier body receptacle 31, 131
Ceramic 32, 132
Opening 33, 133
Coaxial connector 34, 134
Housing 35

1-16. (canceled)

17. A measuring assembly for determining a property of a multi-phase, flowable medium, comprising:
a measuring tube for guiding the medium, wherein the measuring tube has a first antenna receptacle;
a first microwave antenna which is arranged in the first antenna receptacle;
a first separating disc for separating the first microwave antenna from the medium, wherein the first separating disc is arranged in the first antenna receptacle and wherein the first microwave antenna is arranged radially behind the first separating disc in the radial direction; and
a measurement circuit,
wherein the measurement circuit includes a high-frequency generator for supplying the first microwave antenna with an excitation signal,
wherein the measurement circuit is configured to determine the property of the medium on the basis of a received measuring signal.

18. The measuring assembly according to claim 17,
wherein the first separating disc is embodied of:
polyetheretherketones (PEEK);
polytetrafluoroethylene (PTFE);
perfluoroalkoxy (PFA);
glass; or
ceramic.

19. The measuring assembly according to claim 17,
wherein the first separating disc has a first separating disc receptacle in which the first microwave antenna is arranged.

20. The measuring assembly according to claim 19,
wherein the first microwave antenna is fused in the first separating disc receptacle.

21. The measuring assembly according to claim 19,
wherein the first separating disc has a first separating disc section having a first separating disc thickness,
wherein the first separating disc has a second separating disc section having a second separating disc thickness,
wherein the first separating disc thickness is smaller than the second separating disc thickness, and
wherein the first separating disc section forms a minimum separation between the medium and the first microwave antenna.

22. The measuring assembly according to claim 21,
wherein the first separating disc thickness is a maximum of 3 millimeters.

23. The measuring assembly according to claim 17,
wherein the measuring tube has a measuring tube collar extending around a circumference of the first antenna receptacle.

24. The measuring assembly according to claim 17,
wherein the measuring tube has a first measuring tube section with a first outer diameter,
wherein the measuring tube has a second measuring tube section with a second outer diameter,
wherein the first outer diameter is larger than the second outer diameter, and
wherein the first antenna receptacle is located in the first measuring tube section.

25. The measuring assembly according to claim 17,
wherein the measuring tube has a measuring section in which the first microwave antenna is arranged,
wherein the measuring tube is spherical in the measuring section.

26. The measuring assembly according to claim 17, further comprising:
a first disc holder for fixing the first separating disc in the first antenna receptacle,
wherein the first disc holder is designed and arranged on the measuring tube such that the first separating disc is clamped in the first antenna receptacle.

27. The measuring assembly according to claim 17,
wherein the first separating disc has, in a front section, a sealing means receptacle running around the circumference with a sealing means arranged therein.

28. The measuring assembly according to claim 26,
wherein the first microwave antenna has a metallic carrier body with a carrier body receptacle,
wherein the first microwave antenna has a ceramic with a metallization, which is arranged in the carrier body receptacle,
wherein the first microwave antenna has an opening that extends through the carrier body and the ceramic, and
wherein the first microwave antenna has a coaxial connector which is arranged in the opening.

29. The measuring assembly according to claim 28, further comprising:
a first disc fastener which is designed to fix the first separating disc to the first disc holder and/or the first microwave antenna and to shield the first microwave antenna.

30. The measuring assembly according to claim 29,
wherein the first disc fastener and the disc holder are designed and arranged around the first microwave antenna such that a connection to ground is realized via the metallization.

31. The measuring assembly according to claim 17, further comprising:
a second microwave antenna structurally identical to the first microwave antenna, wherein the measuring tube has a second antenna receptacle diametrically oriented to the first antenna receptacle and wherein the second microwave antenna is arranged in the second antenna receptacle; and
a second separating disc for separating the second microwave antenna from the medium,
wherein the second separating disk is arranged in the second antenna receptacle,
wherein the second microwave antenna is arranged radially behind the second separating disc, and
wherein the second microwave antenna is designed to receive the microwave signal.

32. The measuring assembly according to claim 31, further comprising:
a second disc holder for fixing the second separating disc in the second antenna receptacle,
wherein the second disc holder is designed and arranged on the measuring tube such that the second separating disc is clamped in the second antenna receptacle.

33. The measuring assembly according to claim 32,
wherein the measuring tube has a measuring tube interior,
wherein the first disc holder is connected to the second disc holder via at least one fastening means,
wherein the first disc holder and the second disc holder are arranged on the measuring tube and connected to one another such that the first disc holder and the second disc holder cause a force in a direction of the measuring tube interior on the respective disc holder.
